(19) United States
(12) Patent Application Publication
(10) Pub. No.: US 2024/0393593 A1
(43) Pub. Date: Nov. 28, 2024

(54) SMART CONTACT LENS WITH WAVEGUIDE DISPLAY AND FOCUSING SYSTEM

(71) Applicants: Aleksandr Shtukater, Fair Lawn, NJ (US); Aleksadr Ziskis, Brooklyn, NY (US)

(72) Inventors: Aleksandr Shtukater, Fair Lawn, NJ (US); Aleksadr Ziskis, Brooklyn, NY (US)

(73) Assignee: RaayonNova LLC, Fair Lawn, NJ (US)

(21) Appl. No.: 18/634,743

(22) Filed: Apr. 12, 2024

Related U.S. Application Data
(60) Provisional application No. 63/458,945, filed on Apr. 13, 2023.

(51) Int. Cl. G02B 27/01; G02C 11/00

(52) U.S. Cl. CPC G02B 27/0172; G02B 27/0179; G02C 11/10; G02B 2027/0138; G02B 2027/014; G02B 2027/0187

(57) ABSTRACT

The AR/VR enabled smart contact lens (SCL) system comprising a waveguide electro-optical display/projector component embedded into the substrate of the contact lens. Whereas, waveguide electro-optical component further consists of, at least, projector, input grating and out coupling grating designed to project light into the retina of the eye and corresponding method of operation of such system are disclosed. Furthermore, the imagery projected by such a display into the eye is with regards to 2D or 3D frame of reference enabling the user to refocus and accommodate on different parts of an image with respect to the relevant frame of reference. The display hereby proposed is a wide field of view waveguide display.

### CROSS-REFERENCE

This non-provisional Application claims priority from a prior-filed U.S. provisional Application No. 63/458,945, filed on Apr. 13, 2023, and hereby claims the benefit of the embodiment therein and the filing date thereof.

### FIELD OF INVENTION

The present invention relates to Smart Contact Lens (SCL) system. More specifically, the invention relates to an Augmented Reality (AR)/Virtual Reality (VR) Smart Contact Lens (SCL) system with an embedded waveguide to shift the responsibility of bringing different parts of the image partially or completely by shifting the image into the centre of the eye focus/retina.

### BACKGROUND OF THE INVENTION

AR/VR devices normally carry a series of sensors that enable the said AR/VR device to detect and track an environment with depth sensors, CMOS/CCD sensors, image sensors, LIDAR, Infrared, orientation sensors and so on. The AR/VR system creates a 3D model of the surrounding reality from which a virtual space is then created. Virtual spaces contain virtual objects associated with the 3D Models/3D Mesh of such objects, sourced from reality. These Virtual objects are then placed into such virtual spaces to associate the 3D Model/3D Mesh with the surrounding reality. The virtual object is superimposed on the base virtual space layer. In the case of an AR device, the base layer may be the real-world view as compared to the virtual world in the case of a VR device, when the user's gaze is directed to the location of the environment. Thus, the virtual object shifts on display into appropriate position, corresponding to the external position with which said virtual object is associated in 3D Model/3D Mesh of environment.

Generally, for AR and VR platforms there are two modes of image projection/delivery utilized. Both are useful. In one mode, the image may be projected on an embedded display with regard to a 2 dimensional (2D) frame of reference on display; that is according to the display's x and y coordinates. This is the method of projection that projects a “static” image onto an NED display in an existing AR/VR head-mounted display irrespective of the position of the head and where the user is looking at. An example would be the Microsoft Holo-lens running Windows 10 which projects a stop watch or a timer in the bottom right corner of the peripheral vision in the display and the “START” button is provided on the right side of the left corner. Regardless of the direction of the user of AR/VR headset turns their head and where eyes saccade to the position of an image on display, a priori, does not change. Human vision can be discretely divided into “in focus” vision, “near focus” and “peripheral vision”. Focused vision is up to <5 degrees of visual angle. Up to <20 degrees of visual angle represents near focus vision and the rest is peripheral vision.

With peripheral vision, the user registers interest in parts of observable reality and saccades to it, to bring sought parts of observable reality from peripheral to focused vision; that is, by performing saccades, the user refocuses on different parts of a stationary image. When light is reflected from an object, it enters the retina under a direct angle and is then seen as “in focus”. With each saccade fixation point, the visual cortex takes an image snapshot of the current “in focus” image and after collecting several “in focus” 2D images, the visual cortex stitches a multitude of 2D images into the 3D totality of visual perception thereby creating the visual experience.

Now, a 2D Frame of Reference (FoR) refers to a two-dimensional geometry of the embedded display and is defined by x and y axis, that is vertical and horizontal meridian of the eye; a 3D Frame of Reference refers to real world three dimensional geometry and is defined by Cartesian coordinate system consisting of X, Y, and Z axes, that is 3 dimensional geometry of the external environs of the user.

A 2 dimensional FOR is used in AR/VR applications where imagery needs to be superimposed onto the display with regard to the display's geometry, whereas imagery would normally (on AR/VR headset display or laptop display) be stationary on display irrespective of the external environment and what the user is gazing at. For example, AR or VR display application executing Windows or Android, or iOS operating system shows a frame on display wherein the bottom left corner shows the “Start” button and on the right side of the “Start” button on display an up and down menu is accessible. There may be multiple application icons appearing. Icons that could act as UI (user interface) to specific applications, much like iPhones or android phones' application icons that could be selected and the application would launch. A variety of UI components could be presented to the user and such UI components would be stationary relative to the display and their disposition on display will not be changing relative to external 3D environs regardless of what an external environment of the user is being looked at.

On the other hand, 3 dimensional (3D) FOR is used for AR and VR applications where virtual object imagery needs to be superimposed onto the display with regard to the external geometry of the environment. It has a cartesian coordinate system consisting of X, Y, and Z axes, whereas, imagery would be specially associated with the external environment and could be geometrically associated with external space. The image would be placed into a virtual space corresponding to the external environs. The following is a non-limiting and exemplary implementation provided here for illustration only, the process may consist of several steps: Map the local environment, for example with SLAM (Simultaneous Localization and Mapping) methodology may be used to map current environs of the user, such as room, street, etc. SLAM could be complemented by running ML-RANSAC algorithm.

Normally, in conventional vision systems, whenever an image is displayed in front of the user, such as on TV, a tablet or any other head mounted displays, the location of the display remains constant and only the eye gaze changes direction relative to a stationary part of the image on the display to focus on other portions of the display in order to ascertain the full image data ingestion. Image position on display for external (non-on the eye) displays is stationary and eyes saccade to refocus on different parts of an image. So that multitude of focused vision image snapshots taken at different saccade fixation points would be stitched together by the brain's visual cortex, into the totality of visual perception.

However, in 2D FOR, a transparent or a semi-transparent or non-transparent display is embedded into the contact lens and an image or a video is superimposed onto the real-world objects and is viewed in front of the user or maybe displayed. Such kind of an embedded display is naturally, and spatially associated with and locked in, relative to the position of the human eye. Because the embedded display will be shifting with every movement of the eye (saccade), only a part of the image present at the center of the embedded display, will be in sharp focus and a user will not be able to perceive other parts of the superimposed images in clear focus. Further, the human eye position adjustments will disable the eye from seeing other parts of the image in focus because the embedded display moves with the movement of the human eye and an image disposition on display, a priori, does not change. This is a major problem for “on the eye” display system. As the user cannot naturally refocus on different parts of an image by utilizing the natural saccading mechanism.

To overcome the aforementioned problem, an image on the embedded display may be shown at a center position in order to bring an entire image into focus. In order to display the image at the center position, the image needs to appear as being far away from a user. However, this approach presents a number of limitations, such as: 1) amount of information and image size displayed in focus is minimal, and 2) there is no peripheral view available which further limits the usefulness of such an approach. Moreover, with on the eye display, embedded into the contact lens, there is a problem. Every time, user tries to saccade to bring parts of superimposed image from peripheral view into “in focus” view, the user moves the eye to refocus. With every move of the eye, contact lens moves and consequently display moves with synchronicity and proportionality with the eye. Hence, images superimposed also shift proportionally and in the same direction, as a result the user cannot refocus and saccading fails.

Hence, to render an embedded, contact lens display, useful and practical, in 2D FOR, for a human, it is critically important that the above described limitation is transcended. The solution propounded in the present invention is to partly or completely shift responsibility of bringing different parts of the image displayed into focus, from the eyes to the display. To be in focus, the section of an image must be situated in front of the retina of the eye, at the center of the display. The image has to shift on the display, so as to position the section of an image of interest, at the center of the display bringing it into the focus.

### SUMMARY OF THE INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

To overcome the aforementioned problem and for superimposed stationary images, the following solution is propounded in the present patent application—to partly or completely shift the responsibility of bringing different parts of the image displayed into focus, from the eyes to the display. To be in focus, the section of an image must be situated in front of the retina of the eye, at the center of the display. The image has to shift on the display, so as to position the section of an image of interest, at the center of the display bringing it into the focus.

According to one embodiment, at the beginning a zero point reference is determined by tracking the eye's position for the current image overlaid onto the display. With every shift in the eye's position, the image overlay may be recomputed accordingly so that the part of the image sought by the eye is displayed at the center of the display, in front of the eye's retina, and therefore displayed in focus.

According to another embodiment, a “base point reference” may be selected by the user with any detectable signal or by performing certain actions. For example, the user may trigger taking base point reference by clapping his hands, performing any other hand gesture or by blinking user's eye or by any predefined signal that would be captured by the image capture feature and processed to identify the signal. By tracking changes in focus of the eye, the system may determine whether the eye is focused on the image superimposed on display or the real-world objects in front of the eye.

According to another embodiment, the user may trigger taking base point reference by tracking focus of the eye, in real-time, to determine whether the eye is focusing on the objects at a distance or it is focused on the image on display. This method may be used to switch between Frame of References and for registering an anchor point at the same time. A variety of other detectors of a switch in gaze between outside real object and overlaid image are possible. Methods given above are exemplary only and should not be taken as being limiting to the scope of the invention.

According to one embodiment, the system may be predefined or can be dynamically determined as to where the base point reference should be and when the tacking against the said point reference should stop. The system may stop tracking position of the eye and correlate changes of eye's vector to the image disposition on display at stop point. Stop point may be signalled with hand gestures, voice or other signals. Stop signal may be signalled by change of focus from image on display to the real world objects in front of the user. There may be a variety of other ways to detect a stop point. For 2D FOR, once a stop signal is identified, the image on display may return to its original disposition on display; regardless of the position of the eye.

According to one more embodiment, the contact lens system, runs in 2D FOR mode, tracks focus and/or saccades (eye gaze vector changes) and determines what part of an overlaid image the user is attempting to focus on. In response to attempted refocus (saccade) the system shifts an image on the screen so that the sought after portion of an image comes in focus at the center of the on the eye display. This methodology allows natural use of eyes with on the eye display to browse ‘static’ images in 2D FOR. Present solution is also a prerequisite for SCL based system of control where UI components could be placed across peripheral view statically, in 2D FOR, and could be selected and triggered by an eye saccade only.

### BRIEF DESCRIPTION OF THE DRAWINGS

FIG. 1 discloses smart contact lens according to one embodiment of the present invention.

FIG. 2 discloses general design of wave guide display according to one embodiment of the invention.

FIG. 3 discloses a shape of the display to be used for an eye according to one embodiment of the invention.

FIGS. 4 5 and 6 discloses a sequential “walk” of the eye's gaze through the overlaid, otherwise static image; according to 2D FOR describing one embodiment of the invention.

FIG. 7 discloses a detailed flow diagram for the 2D FOR variation of the active mode process showing one more embodiment of the present invention.

FIG. 8 depicts a detailed flow diagram for the 3D FOR variation of the active mode process showing one more embodiment of the present invention.

FIG. 9 discloses an interplay between virtual space and visible view and how objects in virtual view migrate to the visible view showing one more embodiment of the present invention.

FIG. 10 demonstrates the user performing a saccade down and to the right side according to one embodiment of the invention.

FIG. 11 describes user performing a saccade to the left side according to one embodiment of the invention.

### DETAILED DESCRIPTION OF THE INVENTION

The foregoing summary, as well as the following detailed description of certain embodiments of the subject matter set forth herein, will be better understood when read in conjunction with the appended drawings. As used herein, an element or step recited in the singular and preceded with the word “a” or “an” should be understood as not excluding the plural form of said elements or steps, unless such exclusion is explicitly stated. In this document, the term “or” is used to refer to a non-exclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory or any other type of memory. In one embodiment memory maybe implemented as a binary system or in one embodiment memory maybe implemented as a quantum system. Present disclosure should not be construed as being limited to any specific memory system or architecture; presently disclosed system would work with any memory architecture and memory arrangement. The above memory types are exemplary only, and are thus not limiting as to the types of memory usable for storage of a computer program.

As used herein, the term image refers to a dataset containing color information representing an image. Image maybe synthetically produced by a computer software or hardware or maybe taken with an image sensor. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to the operator's commands, or in response to results of previous processing, or in response to a request made by another processing machine.

The various embodiments and/or components, for example, the modules, elements, or components and controllers therein, also may be implemented as part of one or more computers or processors. The computer or processor may include a computing device, an input device, a display unit and an interface, for example, for accessing the Internet or Intranet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device can also be other similar means for loading computer programs or other instructions into the computer or processor. Processor may have onboard memory or memory maybe remotely situated.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer”.

In the following detailed description, reference is made to the accompanying drawings which form a part hereof, and in which are shown by way of illustration specific embodiments in which the subject matter disclosed herein may be practiced. In one embodiment the computer maybe a binary system computer; in one embodiment computer maybe a quantum system computer. Present disclosure should not be construed as being limited to specific type of computer architecture or system, instead term computer or processor should be taken to mean any computing or processing capability of any kind. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents.

The terminology used in the present disclosure is for the purpose of describing exemplary embodiments and is not intended to be limiting. The terms “comprises,” “comprising,” “including,” and “having,” are inclusive and therefore specify the presence of stated features, operations, elements, and/or components, but do not exclude the presence of other features, operations, elements, and/or components thereof. The method steps and processes described in the present disclosure are not to be construed as necessarily requiring their performance in the particular order illustrated, unless specifically identified as an order of performance.

In an event an element is referred to as being “on”, “engaged to”, “connected to” or “coupled to” another element, it may be directly on, engaged, connected or coupled to the other element, or intervening elements may be present. On the contrary, in an event an element is referred to as being “directly on,” “directly engaged to”, “directly connected to” or “directly coupled to” another element, there may be no intervening elements present. Other words used to describe the relationship between elements should be interpreted in a like fashion. Further, the term “and/or” includes any and all combinations of one or more of the associated listed items.

Although the terms first, second, third, etc. may be used herein to describe various elements, components, regions, and/or sections, these elements, components, regions, and/or sections should not be limited by these terms. These terms may only be used to distinguish one element, component, region, or section from another region, layer or section. Terms such as “first,” “second,” and other numerical terms when used herein do not imply a sequence or order unless clearly indicated by the context.

Term SCL means Smart contact lens; contact lens worn over the cornea of the eye with a variety of embedded electronic, electro-optical or optical components. The term Active Contact Lens should be taken to be synonymous with smart contact lens. For the purposes of the present patent application, the word “transceiver” shall be defined as any device that is capable of either both transmission and reception, or transmission only, or reception only of information signals. Multimedia source data stream—initial or source data set containing data of different type. AR—Augmented Reality, VR—Virtual Reality and MX—Mixed Reality.

Term Saccade means—a rapid movement of the eye between fixation points. Saccades are performed to refocus on different parts of observable reality in order to bring different parts of observable reality from peripheral vision into the focused vision (to the central part of the retina).

GC—grating coupler, maybe an input grating coupler or output grating coupler.

Input coupler grating (aka Input grating coupler) is an optical component that is generally integrated into an optical substrate and is designed to accept/receive light from a display or projector. It may be built of various materials with a variety of methods.

Out coupler grating (aka Out grating coupler) is an optical component that is generally integrated into optical substrate, and is responsible for redirecting light rays into the eye of the wearer. It maybe built of various materials with a variety of methods. It is also known as output grating.

Multimedia data stream-data set containing data of different types, for example, an audio, an image, a video, a text and any other types of data. Multimedia stream—data set containing data of different types, for example, audio, image, video, text and other types of data.

Pre-processing—step connotes preliminary processing step in order to perform initial analysis or classification of the dataset. Pre-processing may also refer to manipulation or dropping or enrichment of data before it is used in order to ensure or enhanced performance.

Image capture sensor—for the purposes of the present patent application the term should be interpreted to mean any sensor capable of registering light condition and to be used for either image or video capture. Term Image capture device—should be interpreted to mean to have identical meaning as term Image capture sensor. Term Image sensor for the purposes of present patent application should be interpreted to mean and to be semantically equivalent to image capture sensor.

Video capture sensor—for the purposes of present patent application the term should be interpreted to mean any sensor capable of registering light condition and to be used for either image or video capture. Term Video capture sensor—should be interpreted to mean to have identical meaning as term Video capture device. Term Video sensor for the purposes of present patent application should be interpreted to mean and to be semantically equivalent to video capture sensor.

The term electronic sensor, for the purposes of present patent, may include electro mechanical sensor or electronic sensors that are micro scale (MEMS) or nano scale (NEMS). The term electronic component(s), for the purposes of present patent, may include electro mechanical component(s) or electronic component(s) that are micro scale (MEMS) or nano scale (NEMS).

For the purpose of description of the present disclosure, the term “embedded display” may be used interchangeably with the terms “integrated display” and “embedded display component” and “embedded display module” and “display unit” and “display module”. For the purpose of description of the present disclosure, the term “display projector component” is used to describe one of display components, as one “display component”. Term “display component” may refer to one of components of display module.

For the purpose of description of the present disclosure, the term “waveguide module” may be used interchangeably with the terms “waveguide display” and “waveguide component” and “waveguide based display”.

For the purpose of description of the present disclosure, the term “processor” may be used interchangeably with the terms “processor component” and “processor module” and “processor unit” and processing unit” and “processing module” and “processor component”. “Processor” may be situated onboard of the contact lens (integrated arrangement) or be located remotely on a paired mother device that performs the computation.

For the purpose of description of the present disclosure, the term “orientation module” maybe used interchangeably with “orientation unit” and “orientation component”.

For the purpose of description of the present disclosure, the term “power module” maybe used interchangeably with “power unit” and “power component”.

For the purpose of description of the present disclosure, the term “communication module” maybe used interchangeably with “communication unit”, or “communication device”. Term “Communication component” refers to a constituent part of communication device. Communication module may consist of number of communication components and devices. Term “Communication component” may refer, to integrated, embedded component of communication device and may consist of transceiver coil and controller. Term “Communication component” may refer, to an off board component of communication device and may consist of transceiver coil and controller, integrated into the paired “parent” device that carries the computational power. For the purpose of description of the present disclosure, the term “focal point sensor” maybe used interchangeably with terms “focus determination component”, “focus determination device” or “focus determination module”. For the purpose of description of the present disclosure, the term “focal point sensing” maybe used interchangeably with terms “focus determination”, “focus tracking” focal point determination” and “focal point tracking”.

The term “focus tracking” refers to multitude of methods that maybe used to track focal changes in the eye, either by observing changes in shape of crystalline lens in the eye, by tracking Purkinje images, particularly Purkinje image (P3) 3, that provides reflection of the outer (anterior) surface of the lens. Also, it is possible to track focal changes, indirectly, by observing and tracking where the eye looks at. Determining the distance and tracking changes in distance of objects looked at before. Also, other methods may be used.

For the purpose of description of the present disclosure, the term “eye position” may be used interchangeably with one of the terms from: “eyes gaze orientation”, “eyes orientation”, “eyes direction”, “eyes directional orientation”, “eyes vector”, or “gaze vector”.

For the purposes of description of the present disclosure, the term “shift factor” may be used interchangeably with the terms “shift adjustment factor” and “display adjustment factor”. The “shift factor” refers to the directional vector and extent of the shift of an image on the display.

For the purposes of description of the present disclosure, the term Frame of Reference (FoR) refers to an observer centric coordinate system. A 2D Frame of Reference refers to a two dimensional geometrically embedded display and is defined by x and y axis; a 3D Frame of Reference refers to real world three dimensional geometry and is defined by x, y and z axes. A 3D Frame of reference allows, for example, a system to track an external environment creating a 3D model of reality and the associated superimposed image to an external (x, y, z) geometry in the virtual space represented by the 3D model of the external reality, allowing an image to stay stationary relative to the external geometry.

Generally speaking 2D Frame of reference is used for stationary images that normally do not change position on display; 2D FOR is a 2 dimensional frame of reference. 3D FOR is a 3 dimensional frame of reference. For the purposes of description of the present disclosure, the term Frame of Reference (FOR) refers to an observer centric coordinate system. There are 2 Frame of references to be discerned: 2D frame of reference and 3D frame of reference.

For the purposes of the present disclosure, the terms “base reference” and “base point reference” and “zero point reference” and “anchor point” refer to the relative position of the eye and corresponding image disposition on display that can be deemed as the starting point for consequent eye gaze orientation tracking and corresponding image position adjustments on display.

Virtual Space-A perceived representational 3D or 2D space created by computer graphics software, and is usually characterized by a Cartesian coordinate system consisting of X, Y, and Z axes. It is a digital environment, frequently multiuser environment and is further characterized by interactivity. Objects can be created and placed inside the environment. For the purposes of the present disclosure, the terms ‘Virtual Reality,’ and ‘Virtual Environment’ (VE) are used interchangeably to describe a computer-simulated place or environment with which users can interact via an interface.

In present patent application, AR/VR Smart Contact Lens (SCL) system with an embedded waveguide based display is disclosed. SCL further integrates imaging system that enables the user to focus, refocus or accommodate on imagery superimposed. It should be understood that the use of term “waveguide based display” implies any of type of micro displaying system where light is propagated via waveguide. There are multiple implementations of waveguide display technology in existence and new are being currently developed. Generally, waveguide is used to conduct electromagnetic energy unidirectional with minimal loss of the strength of the signal, instead of letting the signal to spread out and quickly attenuate. Waveguide represents a medium and a channel where signal can propagate while staying within the confines of the waveguide, similar to propagation of the sound wave in an Organ pipe.

Presently, waveguide based transparent, semi-transparent or non-transparent displays or projectors achieve silicon photonics by integrating various electronic, electro-optical components where optical components are available. In some implementations of waveguide displays there are intermediate grating that performs a variation of light conversion or modulation. In some displays, they are called folding grating. Specifically for AR near-the-eye displays (NED) there is a dual requirement for the display: optics needs to be transparent or semi transparent to enable the user to see through the optical component and see what is in front of the user as well as to be able to transmit light and reflect it back to the user. In AR optical systems, an optical combiner is used to combine a “see through” view and an overlay of an image from the AR display.

There are several possible implementations of micro display/projector component being used or explored, both passive and active display technologies, namely: micro OLED display, micro LED panel or indirect light illumination on liquid crystal based display the likes of transmissive or reflective or transflective LCD or reflective LCOS, other possible implementations of micro display are digital micromirror device (DMD) and laser beam scanner (LBS), other display technologies may be utilized. Many other types of projector displays maybe used.

There are multiple types of waveguides. In one exemplary, non limiting embodiment “array waveguide” may be used. Arrayed Waveguide Gratings (AWG) are optical planar device that is frequently used as multiplexers or demultiplexers. Array of waveguides has imaging and dispersive properties. AWGs also known as Phased arrays (PHASARs) or Waveguide Granting Routers (WRGs) as used in the telecom industry. AWG maybe implemented with a linear emitter being coupled to a waveguide array where the liquid-crystal (LC) switches form. There is line-by-line control of light. The process works in the following manner: a light signal emission by the emitter array, an injection into the waveguide array, and the extraction with the use of LC switches and formation of an image with multitude of LC switches.

In one exemplary, non limiting embodiment geometric waveguide may be used. In one exemplary, non limiting embodiment diffractive waveguide may be used. Advances in diffractive optics made design and fabrication and manufacture of diffractive optical elements (DEOs), economically viable and affordable. Technological parameters of DEOs that have been achieved so far and are being further improved are befitting for AR and VR use. Generally, diffractive waveguide consists of several optical and electro-optical components: a waveguide display comprises micro projector/display, and optical component comprising input coupler (coupler-in), also known as input grating coupler (GC), waveguide and an output coupler (coupler-out), also known as actual out coupler grating; input grating coupler receives rays of light from display or projector and optically redirects and transfers light via waveguide towards the out coupling grating, whereas output coupler redirects light into the eye of the user.

Diffraction grating is a periodic optical structure, where periodicity can be expressed by embossed peaks and valleys on the surface of the material, or alternatively could be described as bright or dark fringes. Fringes structure are achieved by laser interference in the holographic implementation. These formats afford periodicity of refractive index n. with diffraction grating period achievable, at the time, close to or smaller then optical wavelength of visual range ˜380-700 nm, this enables efficient manipulation of light.

According to one embodiment, in diffractive waveguide displays an input coupler and an output coupler may be implemented as planar diffraction grating. According to another embodiment, holographic, polarized thin layer or reflective outcoupling may be utilized. In another embodiment, other advanced waveguide methods may be used. It should be understood that for the purposes of the present patent application, we are not limiting ourselves to the specified hereby waveguide types and methods, these are rather exemplary. It should be further understood that other waveguide types and methods are included in the present patent application.

In the present patent application, we disclose a smart contact lens with an embedded AR/VR micro waveguide display arranged for in-focus image generation and projection into the retina of the eye. Some implementations of waveguide display the intermediate grating that performs variation of light conversion or modulation. In some displays they are called folding grating. Specifically for AR near the eye displays (NED) there is dual requirement for the display: optics needs to be transparent or semi transparent to enable the user to see through the optical component and see what is in front of the user as well as to be able to transit light and reflect it back to the user. In AR optical systems, optical combiner is used to combine a “see through” view and an overlay of an image from AR display.

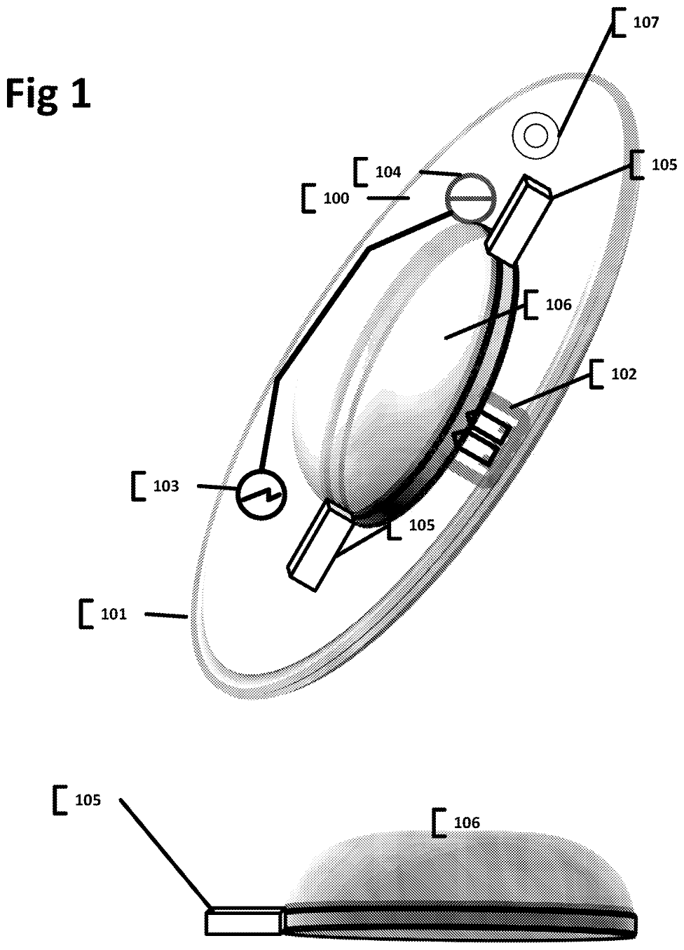

In one exemplary, non-limiting embodiment, as per FIG. 1, smart contact lens 100 is disclosed. Smart contact lens comprises contact lens substrate 101. This invention relies on a rigid scleral lens, however, it should be understood that the present invention relates to all Smart contact lens comprised of the onboard power module 102. Power module 102 may comprise an array of rechargeable nano or micro batteries, for example, Ilika micro batteries or any other batteries or electrical condenser. Power supply module may also comprise wireless recharging subcomponent such as integrated radio antenna that can act as electrical inductor (induction coil) converting electromagnetic energy into an electric current, for example, direct current (DC) and receives RF electromagnetic energy from, near the eye, RF transceiver component. According to one embodiment, RF transceiver component is a near the eye (off contact lens) component, that is part of power supply module.

In one embodiment, the power supply module may comprise, a micro solar panel or an array of solar panels. Other methods of generation of and storage of or generation of electricity may be utilized, for example piezoelectric component that transforms movement of the eye or eye blink into electricity. According to one embodiment, contact lens also comprises electronic depth capture component 103. In one embodiment, the depth capture sensor may be implemented as any micro or nano scale electronic sensor or electro mechanical sensor, capable of determining and tracking of depth information. Depth sensor component may comprise variety of sensors reactive to electromagnetic radiation of various waive length. In one exemplary, non-limiting, embodiment, depth sensor component may comprise non monochrome CMOS or CCD sensor.

In another embodiment, depth sensor component may comprise monochrome IR CMOS or CCD sensor optionally, coupled with an IR emitter. Optionally, it could be implemented as combination of RGB CMOS or CCD sensor and monochrome CMOS or CCD sensors. The likes of Kinect depth camera device. In another embodiment, depth sensor component may comprise LIDAR. The depth sensor component may be implemented as with two RGB CMOS or CCD sensors, by utilizing stereo image information to derive depth information. Any other method could be used to determine or compute depth information.

According to one embodiment, depth information may be used to build 3D Model/3D Mesh of surrounding environment. Depth information may be used to 3D virtual space of surrounding environment. Changes in depth information may be used to determine and track orientation and vector changes relative to external environment. Depth information may be utilized to run SLAM or RANSAC or any other similar methodology.

According to one embodiment, the depth sensor component may be implemented with time of flight methodology. For example: LED or Laser maybe used and modulated light source and associated sensor detects reflected light or detects phase change or reflected light. In one embodiment, depth information may be used to determine orientation and direction of eye's gaze and information needed to determine what information should be presented to the user at any given period of time. Furthermore, orientation of the eye may be determined by correlating current depth image against pre-build possibly with SLAM, 3D Model/Mesh of current environs, room, hall, street, etc.

According to one more embodiment, the system may optionally comprise display controller component 104, comprises electronics on micro electronics (MEMS) or nano electronics scale and optionally comprises computing capability. Display controller component controls display projector component 105 of embedded micro waveguide display device. Display projector component 105 may be implemented as any micro or nano scaled display device. In another embodiment, display projector component 105 maybe be situated externally to the contact lens and can be located on pensne like device worn on the nose or maybe located on glasses like device worn over the face. In this exemplary embodiment, display projector projects light directly onto the contact lens input grating for further transformations, if any, and transmission to output grating.

According to one embodiment, display projector component 105 maybe implemented as micro or nano Liquid Crystal Over Silicon (LCoS) display/projector, as micro or nano Light Emitting Diode (LED) display, as micro or nano Liquid Crystal Display (LCD) display or micro OLED. In one embodiment, display projector component 105 maybe implemented as digital micromirror device (DMD) and laser beam scanner (LBS) device or as any other display or projector device capable of projecting electromagnetic radiation. In one embodiment, display projector component 105 maybe implemented as any other active or passive micro display device. In another embodiment, there is single display projector component 105 projecting entire image. In one exemplary, non-limiting, embodiment, display projector component 105 may comprise multiple projectors.

According to one embodiment, if multiple projectors 105 are used, each of the projectors would project a part of the complete image or each projector 105 may project an entire image. In one embodiment, display component 106 is a specialized waveguide lens component comprising, at least, input coupler and output coupler sub components. Component 106 can be implemented as any type of waveguide display. In one embodiment, waveguide display may be implemented with Macro optics, such as Freedom partially reflective lens, with traditional method or with for example Freedom prism or partially reflective mirrors array or any other type of Macro optics. In one embodiment, waveguide display may be implemented with micro optics, such as surface relive grating (SRG) with input coupler or output coupler implemented as SRG.

According to one embodiment, micro optics waveguide display may be implemented as Volume Hologram grating (VHG), with input coupling or output coupling implemented as VHG. In one embodiment, micro optics waveguide display may be implemented as Polarization volume grating (PVG) with input coupler or output coupler implemented as PVG. In one embodiment, micro optics waveguide display may be implemented as any other micro optics component. In one embodiment, waveguide display may be implemented with nano optics, such as metalenses or metasurface reflectors or any other nano scaled optics technology or method.

According to one embodiment, orientation component 107 may be implemented as any micro or nano scale electronic sensor or electro mechanical sensor, capable of determining orientation and vector. 107 is an orientation component that may comprise accelerometer, compass, gyroscope or inertial measurement unit (IMU) any other sensor capable of reacting and tracking to vector changes of the eye. Orientation component 107 determines current orientation of the eye as well as tracking gaze vector changes during saccades. An orientation component may report the following three values in degrees:
(i) Roll: 0 degree when the device is leveled, increasing to 90 degrees as the device is tilted up onto its left side, and decreasing to −90 degrees when the device is tilted up onto its right side.
(ii) Pitch: 0 degree when the device is leveled, increasing to 90 degrees as the device is tilted so its top is pointing down, then decreasing to 0 degree as it gets turned over. Similarly, as the device is tilted so its bottom points down, pitch decreases to −90 degrees, then increases to 0 degree as it gets turned all the way over.
(iii) Azimuth: 0 degree when the top of the device is pointing north, 90 degrees when it is pointing east, 180 degrees when it is pointing south, 270 degrees when it is pointing west, etc. Orientation information may be reported and presented in different units and formats, depending on underlying hardware used. In one exemplary, non-limiting, embodiment, orientation may be tracked from near the eye glasses or other near the eye device with rear facing camera. Saccade or change of vector of gaze of the eye information maybe used for number of purposes. In one, non limiting, exemplary embodiment, eye gaze vector changes information is used to determine attempted saccade or attempted accommodation or attempted refocus.

According to one embodiment, in response to attempted accommodation or refocus, the SCL system, while in 3D Frame of reference, would shift an image from virtual space into the view of the user and into focus at the center of display or will bring virtual object from virtual space into peripheral view of the user. In one embodiment, in response to attempted accommodation or refocus, the SCL system, alternatively will remove virtual object overlaid from the screen and the object will remain in virtual space. It is important to note that normally, the system will be redrawing the imagery visible to the user from virtual space and as such entire gamut of virtual objects existing in virtual space, where some virtual objects may be spatially associated with 3D model of virtual space, will be shifting proportionately depending on where the user saccades to relative to virtual space. The technique is well known in the art of AR/VR image processing. There are number of other tangent/similar methods that might be used to achieve same result.

According to one exemplary embodiment, in response to attempted accommodation or refocus, the SCL system, while in 2D FOR, would shift image from its current position on display into the view of the user and into focus. In one exemplary embodiment, eye gaze vector changes information is used to determine attempted saccade or attempted accommodation or attempted refocus. In order to determine attempted refocus or accommodation, optionally focus determination and tracking component may be utilized. In one embodiment, on the eye, 110 focus determination/change component may be used to measure electric impulse of ciliary muscles or sensor of actual deformation of the ciliary muscle may be used.

According to one embodiment, Purkinje image corresponding to reflection of the crystalline lens maybe tracked to determine focus change. There are 4 Purkinje images/reflections that are deductible and traceable, these are (P1) reflection from the outer surface of the cornea, (P2) reflection from the inner surface of the cornea, (P3) reflection from the outer (anterior) surface of the lens, (P4) reflection form the inner (posterior) surface of the lens. For purposes of detecting focus and changes in focus, the system would need to track P3 and/or P4 Purkinje reflections. Also, crystalline lens may be tracked with variety of other means, for example, irradiation by rear facing IR emitter of crystalline lens and registering the IR response from crystalline lens. Other methods maybe used to determine and track focus changes in the eye.

According to one embodiment, communication module of the proposed AR SCL system, comprises, an onboard communication component 108, that is embedded into the contact lens. Communication component is configured to communication external device or paired contact lens. Communication is performed utilizing electro magnetic radiation using one of known or proprietary communication protocols. component 108 may utilize bluetooth or wifi communication protocol to communicate with any number of paired devices. In one embodiment, communication component communications with paired contact lens.

According to one embodiment, communication component communicates with external device. In one embodiment, communication component may be implemented as an onboard antenna disposed on the peripheral part of the SCL device. The antenna may also play a dual role as induction coil for wireless power supply module. In one embodiment, the communication component 108, may transfer data, video, image or audio information. In one embodiment, communication component 108, may transfer data, in binary or analog or quant information form. In one embodiment, communication component 108, may be configured to transfer image data from an low or high resolution onboard forward facing image capture device 109 to an external device that does 3D processing and prepares images for contact lens to depict to the user. The visual information may flow back to the contact lens via antenna of communication component 108. In one embodiment, communication component 108, may be configured to transfer depth image data from a low or high resolution onboard forward facing depth capture device 109. In one embodiment, image capture device 109 may be implemented as image or depth image capture device.

According to one embodiment, image capture device 109 may be implemented with CMOS sensor. In one exemplary, non-limiting, embodiment, image capture device 109 may be implemented with CCD sensor. In one embodiment, depth image capture device 109 may be coupled with IR emitter.

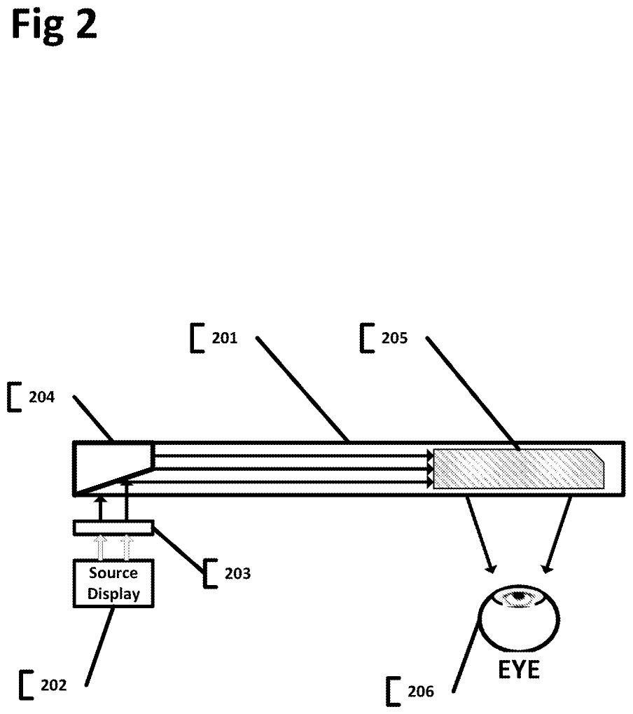

Now referring to FIG. 2, which depicts general design of waveguide display. Component 201 is a waveguide display substrate. Component 202 is a source display/projector. Display component 202 maybe implemented as micro or nano Liquid Crystal Over Silicon (LCoS) display/projector. In one embodiment, display component 205 maybe implemented as micro or nano Light Emitting Diode (LED) display or display component 202 maybe implemented as micro or nano Liquid Crystal Display (LCD) display. In one embodiment, display component 202 maybe implemented as micro OLED. In one embodiment, display component 202 and 205 components maybe implemented as digital micromirror device (DMD) and laser beam scanner (LBS) device. In one embodiment, display component 202 maybe implemented as any other active or passive micro or nano scaled display device. In one embodiment, component 203 is an optional focusing lens component that constitute projection system of the waveguide display. In one embodiment, display component 204 is an in coupling component that maybe implemented as a reflective mirror, or SRG, or VHG or PVG or metalens or metasurface reflector some other form of inbound coupler. In one embodiment, any other known or existing in coupling functionality may be implemented. Component 205 is an out coupler. In one exemplary, non-limiting, embodiment, display component 205 may be implemented as SRG, or VHG or PVG or metalens or metasurface reflector or as form of diffractive reflector or any other type of out coupler. 206 depicts to the eye of the user.

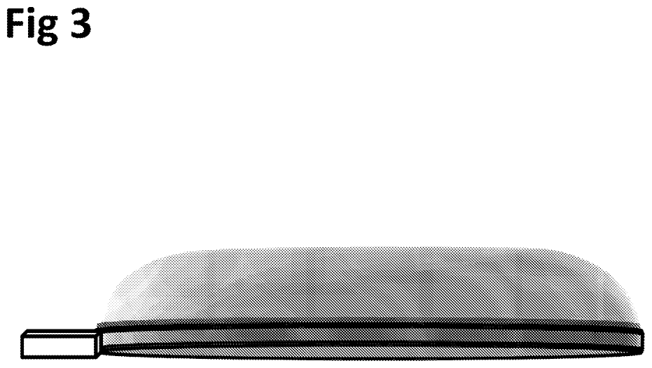

Now referring to FIG. 3 which depicts the preferable “on the eye” display. Currently existing near the eye micro HMD are flat or nearly flat. However, for an “on the eye” display that needs to be integrated into contact lens substrate, it is preferable for such display to have a concaved shape or approximation of concave shape.

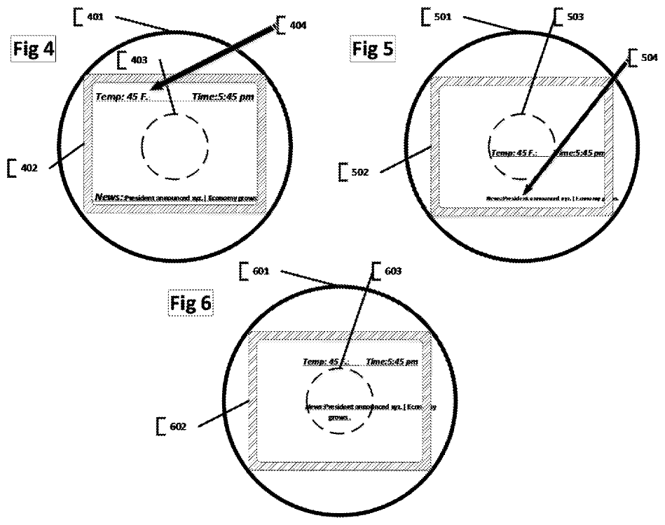

Now referring to FIGS. 4, 5 and 6 which discloses sequential “walk” of the eye's gaze through the overlaid on otherwise static image according to 2D FOR. In FIG. 4 an active contact lens 401 with an embedded onboard display 402 is shown. Display 402 may be of any shape. In one embodiment, waveguide display may be round. In an alternate embodiment, display may be square or rectangular, etc. Section 403 shows portion of display where image will be seen in sharp focus at the center of display. In FIG. 4, base reference is middle of the screen and 404 arrow points to location on the display where some data is displayed. The data section pointed to by 404 arrow is of interest to the user.

According to one embodiment, first, the system takes the base reference, that is, the system determines the position of the eye and current disposition of the image on display. Secondly, with the shift of an eye, as per FIG. 5, the system of an active contact lens 501 correspondingly shifts an image to make it visible on display 502 in focus at section of display 503. FIG. 6 depicts first image adjustment after base reference is determined. Arrow 504 points to the section of superimposed image which is of interest to the user afterwards, as registered by the eye tracking sub-system. The system accordingly adjusts image location on the screen as per exemplary FIG. 6, active contact lens 601, containing display 602 and a shifted image where sought portion of an image data is at the center of the lens at 603 and thus in focus. FIG. 6 depicts second image adjustment after base reference is determined. Once the data ingestion is finished the image on the screen may be refreshed with new data and base reference may be taken again.

According to one embodiment, once, a zero point reference is determined, the tracking of the eye's position begins for the current image overlaid onto the display. With every shift in the eye's position, the image overlay may be recomputed accordingly so that the part of the image sought by the eye is displayed at the center of the display, in front of the eye's retina, and therefore displayed in focus. Here overlaid entire image shifts accordingly. In one embodiment, “base point reference” may be selected by the user with any detectable signal, with triggering action. In one embodiment, the user may trigger taking base point reference by clapping his hands. In another embodiment, the user may trigger taking base point reference by eye blink. In one embodiment, the user may trigger taking base point reference by predefined signal that would be captured by image capture device and processed to identify the signal; for example certain sequence and form of hand gestures.

According to another embodiment, by tracking changes in focus of the eye, the system may determine whether the eye is focused on the image superimposed on display or the real world objects in front of the eye. In one embodiment, the user may trigger taking base point reference by tracking focus of the eye, in real-time, to determine whether the eye focusing on the objects at a distance or it is focused on the image on display. This method may be used to switch between Frame of References and for registering anchor point at the same time. Variety of other detectors of a switch in gaze between outside real object and overlaid image are possible. Methods given above are exemplary only and should not be taken as being limiting to the scope of the invention.

According to one embodiment, the system may predefine or dynamically determine where base point reference should be and when the tacking, against said point reference, should stop. The system may stop tracking position of the eye and correlate changes of eye's vector to the image disposition on display at stop point. Stop point may be signaled with hand gestures, voice or other signals. Stop signal may be signaled by change of focus from image on display to the real world objects in front of the user. There may be variety of other ways to detect stop point. For 2D FOR, once stop signal is identified, the, otherwise static, image on display may return to its original disposition on display; regardless of the position of the eye.

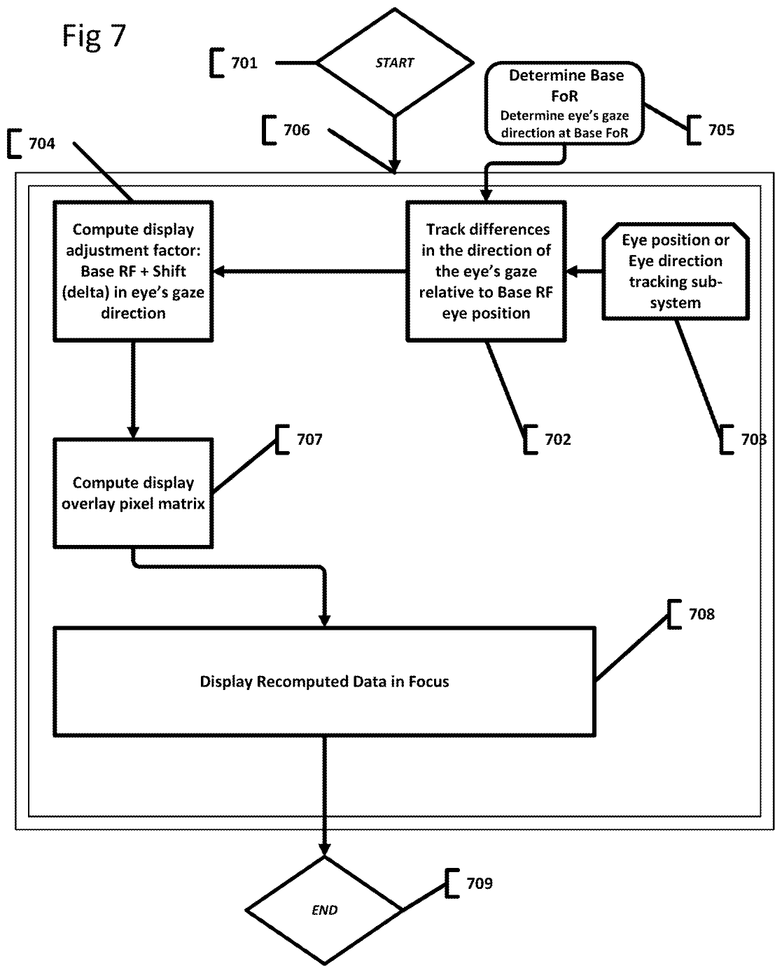

Now referring to FIG. 7, which depicts a detailed flow diagram for the 2D FOR variation of the active mode process. The process starts at step 701, for example, by turning the contact lens system to an “ON” state. At step 705, base reference is determined and used as the starting position to determine the eye's gaze shift at step 702. At step 703, the directional change in the eye's position is determined. At step 704, the system computes shift adjustment factor based on base reference and delta in the eye's direction relative to the base reference point. In one embodiment, shift adjustment factor may be represented as vector value indicating angle and extent of the shift required in the disposition of an image. Shift adjustment factor may be represented as an angle measure and value measure, whereas angle indicates angle (direction) of the shift and value measure indicates extent of the shift in the direction of the angle. It should be understood that shift factor, also known as shift adjustment factor may be expressed in variety of ways and given here suggestions are for illustration only and in no way are limiting to the scope of the invention.

Furthermore, at step 707 the system computes per pixel image matrix based on the shift adjustment factor. There are variety of ways the computation may be achieved, for example with matrix mathematics, trigonometric models and so on. Further, the computed image is output to the display at step 708, so that sought part of image is displayed at the center and is situated at the center of the eye, against eye's retina and thus new portion of an image comes into focus. At the same time the portion of the image that has been in focus previously shifts to the peripheral zone of the display. This process is repeated in a loop 706. Step 709 signifies end of the process and may be triggered, for example by user command, by switching to another Frame of Reference. Step 709 may be triggered by an eye changing focus from the overlaid image to the outside view. In one embodiment the SCL system may provide imagery to the user with respect to 3D FOR, that is the imagery is superimposed with respect with external geometry around the user and external objects are aligned and positioned relative virtual space.

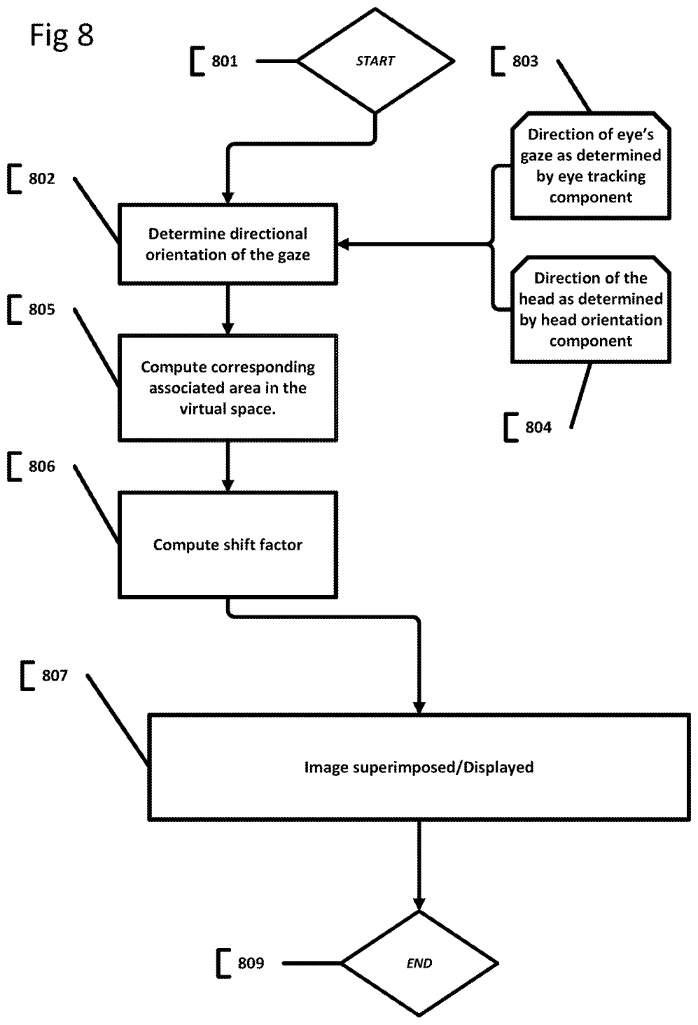

Now referring to FIG. 8 that depicts a detailed flow diagram for the 3D FOR variation of the active mode process. Step 801 describes start of the process and may constitute turning AR/VR contact lens to an “ON” state or may be a result of a switch made from 2D FOR processing to 3D FOR processing, it may also mean, start of the process initiated by any means or for example starting an application that requires 3D FOR. The process goes in a loop. In one embodiment, FIG. 8 describes one pass of the loop. At step 802, the system determines orientation and gaze vector based on inputs from the orientation module. Orientation module may comprise compass, gyro scope, tilt sensor and accelerator or any other sensor capable of determining directional orientation of the eye(s) or capable of tracking saccades. Orientation module may comprise components embedded into the contact lens substrate or be external to SCL.

According to one embodiment, the system may determine and rely on orientation relative to external environment. In one embodiment, the system may use SLAM (simultaneous localization and mapping) methodology, to map the room, hallway, buildings, street, valley with trees, etc. where the user is located to create 3D model of external reality. In one exemplary, non-limiting embodiment, an SCL system may achieve that by utilizing at least one integrated into contact lens substrate, forward facing image capture device or depth capture device or combination of the two. Image capture device may comprise CMOS or CCD sensor or any other type of sensor implemented as MEMS or nano-scaled device. Consequently, orientation may be determined by correlating information derived from image or depth capture device against 3D Model that forms virtual space. Orientation may be determined relative to pre-mapped 3D Model of current environment.

According to one embodiment, the system may determine orientation by combining information from orientation sensors and image or depth capture devices. In FIG. 8, at steps 803 and 804 the system derives information about orientation either from embedded orientation sensors or external sources of orientation information, such as on the headset or smart glasses camera. At step 805 the system computes and determines zone in virtual space that the eyes are targeting at any given time. At 806 the system generates new image from virtual space corresponding to the current gaze vector. The saccades of the eye are tracked and with every detectable change in the vector of the eye its geometrical correlation to virtual space is computed. At step 807, the system displays an image overlay onto the display. Process ends at step 808, with the SCL being turned to an “OFF” state or some other means of causing the system to stop tracking and building and maintaining virtual space. For example, an end of the process maybe closing an application on AR/VR SCL system.

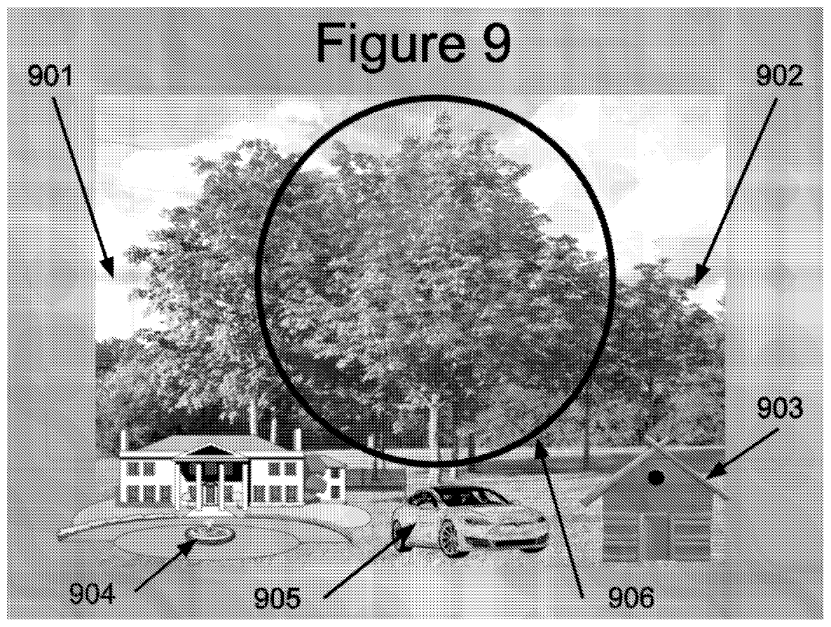

According to one embodiment, FIG. 9 further demonstrates an interplay between virtual space and visible view and how objects in virtual view migrate to the visible view. 901 is an image of what the user of AR/VR SCL platform has in front of himself/herself. 901 demonstrates a merged view of reality 903 (actual house that is part of real view) and objects from virtual space. According to another embodiment, 906 denotes the visible spectrum of the AR SCL at current gaze vector and angle. 902 refers to the layer of actual visible view before virtual space overlay happens. 904 is a virtual mansion/house object in virtual space outside of visible to the user area. Virtual mansion object exists in virtual space, in operating memory, and is attached and geometrically associated with the 3D Model of reality. However, the virtual objects exist in virtual space in connection with 3D Model of reality that is built in memory of AR/VR SCL device, and is geometrically associated with the 3D Model of reality. According to one embodiment, 905 is a virtual object (auto Tesla) residing in virtual space but not visible at current gaze vector. Virtual object (Tesla) is attached to virtual space.

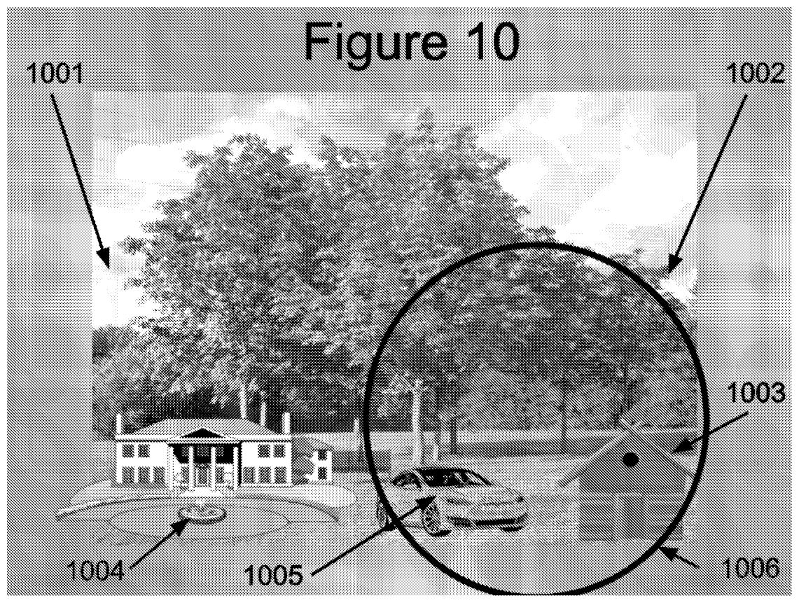

Now, hypothetically, the user performs a saccade down and to the right side, and whatever the user of AR/VR SCL platform has in front of himself/herself is demonstrated in FIG. 10. 1001 depicts a merged view of reality, 1003 (actual house that is part of real view) and objects from virtual space, 1003 is in present view of the user. 1006 denotes the visible spectrum of the AR SCL at current gaze vector and angle. 1002 refers to the layer of actual visible view. FIG. 10 depicts the same view but with a different eye gaze vector. 1001 is an image of what before virtual space overlay happens. 1004 is a virtual mansion/house object in virtual space outside of visible to the user area. Virtual mansion object exists in virtual space, in operating memory, and is attached and geometrically associated with the 3D Model of reality. 1005 is a virtual object (auto Tesla) residing in virtual space and becomes visible at current gaze vector.

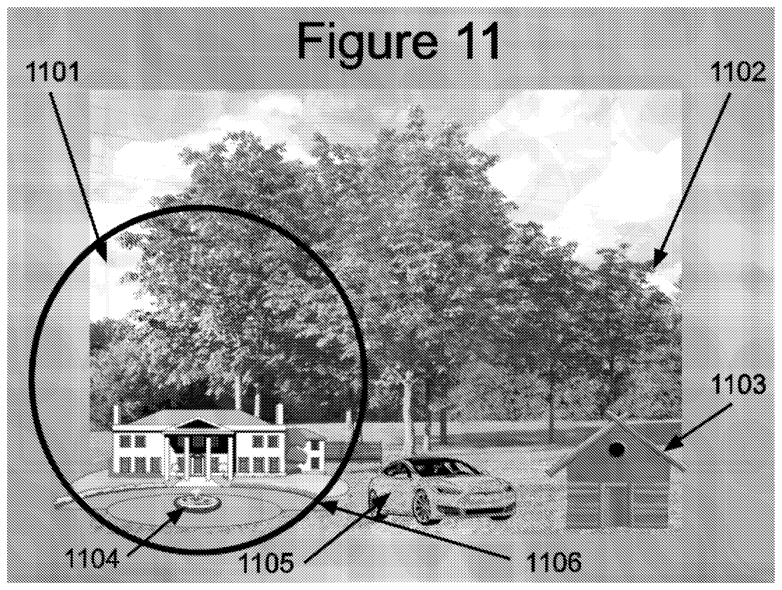

According to one embodiment, now the user performs a saccade to the left side, as is demonstrated in FIG. 11. 1101 depicts a merged view of reality, 1013 objects from virtual space, 1103 is not in present view of the user. 1106 denotes the visible spectrum of the AR SCL at current gaze vector and angle. 1102 refers to the layer of actual visible view. FIG. 11 depicts the same view but with a different vector of the gaze. 1104 is a virtual mansion/house object in virtual space comes into the zone visible to the user as a result of the latest saccade. The virtual mansion, exists in virtual space and is geometrically attached to and is associated with particular location within 3D model of external reality, gets into the view of the user. 1105 is a virtual object (auto Tesla) residing in virtual space and is geometrically associated and attached to specified location in 3D Model and becomes invisible at new gaze vector. 1106 is the actual merged view presented to the observer.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A contact lens system, comprising:
a contact lens substrate;
a power supply module;
an embedded waveguide module, further comprising:
at least one projector,
at least one input grating, and
at least one out coupling grating designed to project light into the retina of the eye.

2. The contact lens system of claim 1, wherein a forward facing image capturing device or a depth image capturing device is embedded into the contact lens.

3. The contact lens system of claim 1, wherein the said power supply module provides power to the contact lens system and further comprises:
an onboard induction coil and external source of electro magnetic radiation configured to broadcast energy for onboard induction coil to induce electric current for consequent storage or immediate utilization by the contact lens system
or
at least one battery to store electric charge and to power electro-optical components of the lens system or
at least one piezoelectric sensor to generate electric current from movement of the eye or
at least one light sensor to generate electric current from incident light.

4. The contact lens system of claim 1, further comprises a communication module, which further comprises:
a communication device embedded in the contact lens; whereas,
the communication device configured to communicate with one or more external communication device or with another paired contact lens.

5. The contact lens system of claim 1, further comprises a processor module that is situated onboard of the contact lens system or external to the contact lens and is configured to process computer instructions executing computer program.

6. The contact lens system of claim 5, wherein the said processor module is configured to compute image disposition on embedded display relative to 3 dimensional or 2 dimensional frame of reference.

7. The contact lens system of claim 5, wherein the said processor module is configured to track external geometry by building and maintaining 3d mesh in memory based on inputs from the forward facing image or depth image capture sensor.

8. The contact lens system of claim 1, further comprises a focus determination device.

9. The contact lens system of claim 1, further comprising antenna curled around at the periphery of the contact lens, whereas antenna is configured to function as
A communication transceiver for communication module or as
An induction coil for the power supply module.

10. A method of operating a contact lens system, comprising:
powering the contact lens device with an embedded waveguide module by an integrated power supply module;
projecting light onto an input grating, from display projector; and
outputting light from output grating of the waveguide.

11. The method of claim 9, further comprising obtaining an image/depth image from a forward facing image capture device embedded into the contact lens system.

12. The method of claim 9, wherein the said power supply module provides power to the contact lens system and further comprises;
an onboard induction coil and external source of electro magnetic radiation configured to broadcast energy for onboard induction coil to induce electric current for consequent storage or immediate utilization by the contact lens system or
at least one battery to store electric charge and to power electro-optical components of the lense system or
at least one piezoelectric sensor to generate electric current from movement of the eye; or
at least one light sensor to generate electric current from incident light.

13. The method of claim 9, further comprising:
establishing and maintaining communication between at least one contact lens and external communication device;
or establishing and maintaining communication between two paired contact lenses.

14. The method of claim 9, further comprising the said processor module, situated onboard of the contact lens system or external to the contact lens and configured to process computer instructions executing computer program.

15. The method of claim 13, wherein the said processor module processes image disposition on embedded display relative to 3 dimensional or 2 dimensional frame of reference.

16. The method of claim 13, wherein the said processor module is configured to track external geometry by building and maintaining 3d mesh in memory based on inputs from the forward facing image or depth image capture sensor or from any other source of information.

17. The method of claim 9, further comprising:
determining and/or tracking orientation of the eye with orientation module embedded into the contact lens deice; or
determining and/or tracking orientation of the eye by tracking output of image or depth image capture device.

18. The method of claim 9, further comprising determining or tracking focal point of an eye at any given point of time.

19. The method of claim 9, further comprising:
The said processor module configured to compute disposition of an image on display according to either 3D or 3D Frame of reference, overlay an image(s) onto the real world view in 3D mesh,
the said communication module, further communicates the image and optionally its disposition of an image on display to the contact lens display and
the said embedded waveguide display projecting the image in the right position.
